(19) United States
(12) Patent Application Publication
(10) Pub. No.: US 2026/0276537 A1
(43) Pub. Date: Sep. 17, 2026

(54) POLYMER MONITORING DEVICE AND METHOD USING TERAHERTZ WAVES

(71) Applicant: IUCF-HYU (INDUSTRY-UNIVERSITY COOPERATION FOUNDATION HANYANG, Seoul (KR)

(72) Inventors: Hak Sung KIM, Seoul (KR); Sang ll KIM, Seoul (KR)

(73) Assignee: IUCF-HYU (INDUSTRY-UNIVERSITY COOPERATION FOUNDATION HANYANG, Seoul (KR)

(21) Appl. No.: 19/531,903

(22) Filed: Feb. 6, 2026

Related U.S. Application Data
(63) Continuation of application No. PCT/KR2024/009844, filed on Jul. 10, 2024.

(30) Foreign Application Priority Data
Sep. 4, 2023 (KR) 10-2023-0116827
Dec. 14, 2023 (KR) 10-2023-0182071

(51) Int. Cl. G01N 21/3563; G01B 11/06; G01N 21/3581; G01N 21/84

(52) U.S. Cl. CPC G01N 21/3563; G01B 11/0625; G01N 21/3581; G01N 21/8422; G01N 2021/8427

(57) ABSTRACT

A polymer monitoring device using terahertz waves is provided. The polymer monitoring device using terahertz waves may comprise: an emitter which emits terahertz waves toward a polymer thin film coated on a target substrate; a detector which detects terahertz waves emitted from the emitter and reflected from a surface of the target substrate or terahertz waves penetrating the polymer thin film and the target substrate; and a monitoring unit which, during curing of the polymer thin film, acquires thickness and refractive index information of the polymer thin film in real time through the terahertz waves detected by the detector.

### CROSS REFERENCE TO RELATED APPLICATIONS

This application is a Bypass continuation of International Application No. PCT/KR2024/009844, filed on Jul. 10, 2024, which claims priority from Korean Application No. 10-2023-0116827, filed on Sep. 4, 2023, and Korean Application No. 10-2023-0182071, filed on Dec. 14, 2023, the contents of all of which are incorporated herein by reference in their entirety.

### TECHNICAL FIELD

The present invention relates to a polymer monitoring device and a polymer monitoring method using terahertz waves, and more particularly, to a polymer monitoring device and a polymer monitoring method using terahertz waves, capable of monitoring a curing state of a polymer thin film coated on a substrate in real time.

### BACKGROUND ART

A polymer refers to a material used in various industrial fields. For example, a polymer used in the semiconductor field is coated on a substrate through spin coating or the like, and subjected to a curing process so as to form a functional layer.

However, conventionally, a curing state of a polymer could not be measured or checked in real time during a process of coating a polymer.

In other words, conventionally, the state of the polymer could only be checked after the polymer has been fully cured. Accordingly, even when an abnormality has occurred in a material or a device during a process of forming a polymer layer, an immediate reaction could not be taken so that product defects have frequently occurred.

In addition, conventionally, the curing state of the polymer has been checked after the polymer has been fully cured so that a process completion time has been delayed, and the curing state of the polymer has been checked through a physical device so that there has been a concern that damage would occur to the formed polymer layer.

In particular, as a wafer area becomes large, and a line width becomes fine, an influence of a yield of a photoresist (PR) on a product yield becomes greater so that an active measure for enhancing the yield of the photoresist (PR) during a curing process for the photoresist (PR) is required.

### DISCLOSURE

### Technical Problem

One technical object of the present invention is to provide a polymer monitoring device and a polymer monitoring method using terahertz waves, capable of monitoring a curing state of a polymer thin film coated on a substrate in real time.

Technical objects of the present invention are not limited to the technical object described above.

### Technical Solution

To achieve the technical object described above, the present invention provides a polymer monitoring device using terahertz waves.

According to one embodiment, the polymer monitoring device using the terahertz waves includes: an emitter for generating terahertz waves toward a polymer thin film coated on a target substrate; a detector for detecting terahertz waves generated from the emitter and reflected from a surface of the target substrate, or terahertz waves transmitted through the polymer thin film and the target substrate; and a monitoring unit for acquiring thickness and refractive index information of the polymer thin film in real time through the terahertz waves detected by the detector during curing of the polymer thin film.

According to one embodiment, the monitoring unit may calculate a refractive index and a thickness of the polymer thin film in consideration of a ratio of a frequency domain value of the terahertz waves in the target substrate and a frequency domain value of the terahertz waves in a reference substrate, and the reference substrate may be defined as a substrate that is not coated with the polymer thin film.

According to one embodiment, the refractive index (ñₚ) of the polymer thin film may be calculated through Formula 1 below, and the thickness (dₚ) of the polymer thin film may be calculated through Formula 2 below,

$$\begin{matrix}\frac{FFT [ {E}_{t} ( t ) ]}{FFT [ {E}_{r} ( t ) ]} = \frac{{T}_{ap} \cdot {D}_{p} \cdot {R}_{ps} \cdot {D}_{p} \cdot {T}_{pa}}{{D}_{a} \cdot {R}_{as} \cdot {D}_{a}} = ρ \cdot {e}^{- j φ} \\ = \frac{4 {\tilde{n}}_{a} {\tilde{n}}_{p} cos ( θ1 ) cos ( θ 2 )}{{( {\tilde{n}}_{p} cos ( θ 2 ) + {\tilde{n}}_{a} cos ( θ 1 ) )}^{2}} . {e}^{- j ( 2 \frac{{\tilde{n}}_{p} ω {d}_{p}}{c} - 2 \frac{ω {d}_{a}}{c} )}\end{matrix} \qquad [ Formula 1 ]$$

$${d}_{p} = cos ( θ 2 ) \frac{φ c}{2 ω ( {\tilde{n}}_{p} - 1 )} \qquad [ Formula 2 ]$$

where Eₜ (t) is a terahertz wave reflected from a surface of a target substrate coated with a polymer thin film, Eᵣ (t) is a terahertz wave reflected from a surface of a reference substrate, ω is a frequency of a terahertz wave, φ is a phase difference between a terahertz wave reflected from a surface of a target substrate coated with a polymer thin film and a reference terahertz wave, c is a speed of light, θ1 is an angle of incidence of a terahertz wave, θ2 is an angle of refraction of a terahertz wave, Tₐₚ and Tₚₐ are transmittance coefficients between air (a) and a polymer thin film, Dₐ is an absorption coefficient of air, Dₚ is an absorption coefficient of a polymer thin film, Rₚₛ is a reflection coefficient between a target substrate and a polymer thin film, Rₐₛ is a reflection coefficient between a reference substrate and air, dₐ is a thickness of an air layer that is set to correspond to a polymer thin film, and ñₐ is a refractive index of an air layer.

According to one embodiment, the detector may further detect terahertz waves reflected from an inside of the target substrate, and the monitoring unit may acquire the thickness and refractive index information of the polymer thin film in real time even through the terahertz waves reflected from the inside of the target substrate.

According to one embodiment, the emitter and the detector may scan an entire area of the polymer thin film.

According to one embodiment, the polymer monitoring device may further include a database, the database may store a reference range for a refractive index and a thickness for each stage of the curing of the polymer thin film, and the monitoring unit may monitor whether the thickness and refractive index information of the polymer thin film acquired in real time is included in the reference range.

According to one embodiment, the monitoring unit may provide a result of the monitoring as cause analysis data for an abnormality occurrence when the thickness and refractive index information of the polymer thin film is not included in the reference range.

According to one embodiment, at least one emitter and at least one detector may be provided such that a number of emitters corresponds to a number of detectors.

According to one embodiment, the emitter and the detector may be provided so as to be operable in one measurement mode among a transmission mode, a normal mode, a reflection mode, and a multi-mode in which the transmission mode and the reflection mode are combined based on an optical path of the terahertz wave with respect to the polymer thin film.

According to one embodiment, the terahertz waves may be provided as pulsed waves or continuous waves.

According to one embodiment, a frequency of the terahertz wave may be 0.1 THz to 10 THz.

Meanwhile, the present invention provides a polymer monitoring method using terahertz waves.

According to one embodiment, the polymer monitoring method using the terahertz waves includes: generating terahertz waves toward a polymer thin film coated on a target substrate; detecting terahertz waves reflected from a surface of the target substrate, or terahertz waves transmitted through the polymer thin film and the target substrate; and acquiring thickness and refractive index information of the polymer thin film in real time through the terahertz waves detected in the detecting of the terahertz waves during curing of the polymer thin film.

According to one embodiment, in the generating of the terahertz waves, terahertz waves may be further generated toward a reference substrate that is not coated with the polymer thin film, in the detecting of the terahertz waves, reference terahertz waves may be further detected from the reference substrate, and in the acquiring in real time, a refractive index and a thickness of the polymer thin film may be calculated in consideration of a ratio of a frequency domain value of the terahertz waves in the target substrate and a frequency domain value of the terahertz waves in the reference substrate.

According to one embodiment, in the generating of the terahertz waves and the detecting of the terahertz waves, an entire area of the polymer thin film may be scanned.

### Advantageous Effects

According to an embodiment of the present invention, a polymer monitoring device using terahertz waves may include: an emitter for generating terahertz waves toward a polymer thin film coated on a target substrate; a detector for detecting terahertz waves generated from the emitter and reflected from a surface of the target substrate, or terahertz waves transmitted through the polymer thin film and the target substrate; and a monitoring unit for acquiring thickness and refractive index information of the polymer thin film in real time through the terahertz waves detected by the detector during curing of the polymer thin film.

Accordingly, a polymer monitoring device and a polymer monitoring method using terahertz waves, capable of monitoring a curing state of a polymer thin film coated on a substrate in real time, can be provided. Accordingly, an immediate reaction can be taken upon occurrence of a problem in a polymer curing process, such as, for example, an abnormality in a polymer thin film and an abnormality in a curing device.

In other words, according to the embodiment of the present invention, an active measure for enhancing a yield can be taken during the process.

For example, a curing state of a photoresist (PR) can be monitored in real time during a photolithography process so that an immediate reaction can be taken upon occurrence of a problem.

In addition, the curing state of the photoresist (PR) can be monitored in real time during the photolithography process so that excellent curing quality for stable etching in large wafer areas and fine line widths can be achieved.

### DESCRIPTION OF DRAWINGS

FIG. 1 is a schematic view for describing a polymer monitoring device according to one embodiment of the present invention.

FIG. 2 is a schematic view showing the polymer monitoring device according to one embodiment of the present invention.

FIG. 3 is a schematic view for describing a polymer monitoring device according to one modified example of the present invention.

FIG. 4 is a schematic view for describing a polymer monitoring device according to another modified example of the present invention.

FIG. 5 is a schematic view for describing a polymer monitoring device according to still another modified example of the present invention.

FIGS. 6 to 9 are exemplary views for describing a monitoring unit of the polymer monitoring device according to one embodiment of the present invention.

FIGS. 10 and 11 show results of monitoring a curing state of a photoresist coated on a silicon wafer during curing of the photoresist through the polymer monitoring device according to one embodiment of the present invention.

FIG. 12 is a schematic view for describing a photolithography process monitored in real time by the polymer monitoring device according to one embodiment of the present invention.

FIG. 13 is a flowchart showing, in a process order, a polymer monitoring method using terahertz waves according to one embodiment of the present invention.

### MODE FOR INVENTION

Hereinafter, exemplary embodiments of the present invention will be described in detail with reference to the accompanying drawings. However, the technical idea of the present invention is not limited to the embodiments described herein, but may be embodied in different forms. The embodiments introduced herein are provided to sufficiently deliver the idea of the present invention to those skilled in the art so that the disclosed contents may become thorough and complete.

When it is mentioned in the present disclosure that one element is on another element, it means that one element may be directly formed on another element, or a third element may be interposed between one element and another element. Further, in the drawings, shapes and sizes are exaggerated for effective description of the technical contents.

In addition, although the terms such as first, second, and third have been used to describe various elements in various embodiments of the present disclosure, the elements are not limited by the terms. The terms are used only to distinguish one element from another element. Therefore, an element mentioned as a first element in one embodiment may be mentioned as a second element in another embodiment. The embodiments described and illustrated herein include their complementary embodiments, respectively. Further, the term “and/or” used in the present disclosure is used to include at least one of the elements enumerated before and after the term.

As used herein, an expression in a singular form includes a meaning of a plural form unless the context clearly indicates otherwise. Further, the terms such as “including” and “having” are intended to designate the presence of features, numbers, steps, elements, or combinations thereof described herein, and shall not be construed to preclude any possibility of the presence or addition of one or more other features, numbers, steps, elements, or combinations thereof. In addition, the term “connection” used herein is used to include both indirect and direct connections of a plurality of elements.

In addition, the term such as “ . . . unit”, “ . . . er”, or “module” described herein refers to a unit for processing at least one function or operation, which may be implemented through hardware, software, or a combination of hardware and software.

Further, in the following description of the present invention, detailed descriptions of known functions or configurations incorporated herein will be omitted when they may make the gist of the present invention unnecessarily unclear.

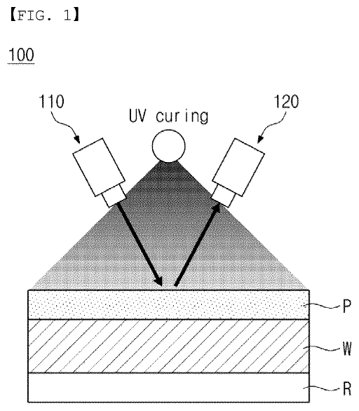

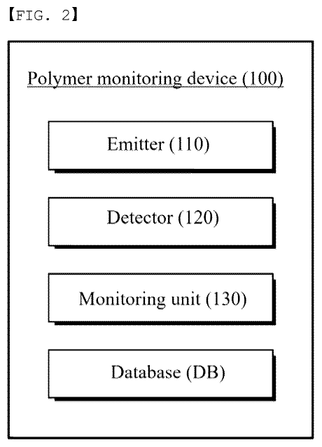

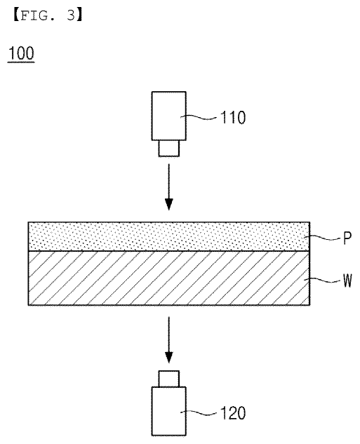

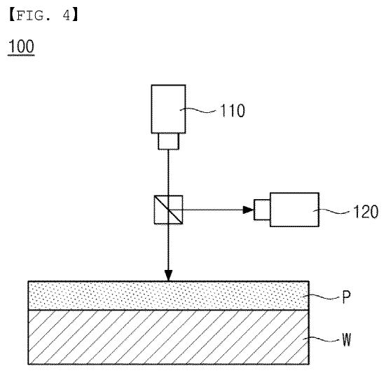

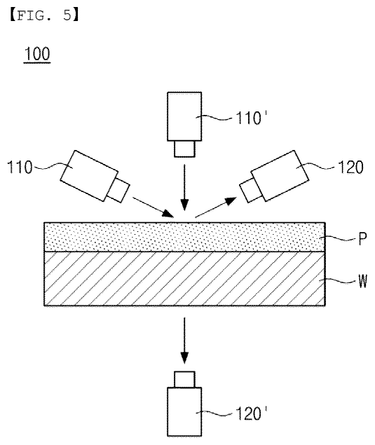

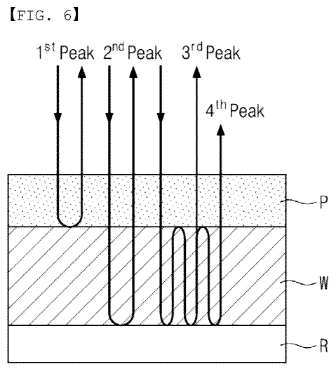

FIG. 1 is a schematic view for describing a polymer monitoring device according to one embodiment of the present invention, FIG. 2 is a schematic view showing the polymer monitoring device according to one embodiment of the present invention, FIG. 3 is a schematic view for describing a polymer monitoring device according to one modified example of the present invention, FIG. 4 is a schematic view for describing a polymer monitoring device according to another modified example of the present invention, FIG. 5 is a schematic view for describing a polymer monitoring device according to still another modified example of the present invention, and FIGS. 6 to 9 are exemplary views for describing a monitoring unit of the polymer monitoring device according to one embodiment of the present invention.

As shown in FIGS. 1 and 2, a polymer monitoring device 100 according to one embodiment of the present invention may include an emitter 110, a detector 120, and a monitoring unit 130.

The emitter 110 may be a device for generating terahertz waves toward a polymer thin film P coated on a target substrate W. To this end, the emitter 110 may be arranged so as to be directed toward the polymer thin film P coated on the target substrate W.

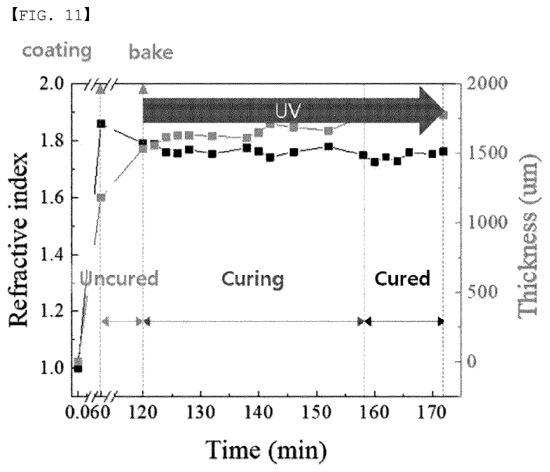

In this case, the polymer thin film P may be coated on the target substrate W and being cured. For example, the polymer thin film P may be a photoresist (PR) coated on the target substrate W configured as a silicon (Si) wafer for a photolithography process (see FIG. 11).

However, since the above configuration is merely one example, according to the present invention, the polymer thin film P is not necessarily limited to the photoresist (PR).

According to one embodiment of the present invention, the emitter 110 may be arranged so as to be inclined at a set angle from a normal direction of the polymer thin film P. For example, the emitter 110 may be arranged so as to be inclined at an angle of 30 degrees from the normal direction of the polymer thin film P. Accordingly, the terahertz waves generated from the emitter 110 may be incident on the polymer thin film P at an angle of 60 degrees based on the polymer thin film P.

According to one embodiment of the present invention, the terahertz waves generated from the emitter 110 and emitted toward the polymer thin film P may be provided as pulsed waves or continuous waves.

In this case, the pulsed terahertz waves may include numerous frequencies so that the pulsed terahertz waves may be detected at once.

In order to generate the pulsed terahertz waves, femtosecond laser that functions as a pump light for generating pulsed terahertz waves may be emitted to the emitter 110.

Meanwhile, according to one embodiment of the present invention, a frequency of the terahertz wave generated from the emitter 110 and emitted to the polymer thin film P may be 0.1 THz to 10 THz.

According to one embodiment of the present invention, the emitter 110 and the detector 120 may be provided so as to be operable in a reflection mode based on an optical path of the terahertz wave with respect to the polymer thin film P.

Accordingly, the detector 120 may be arranged symmetrically with the emitter 110 based on the normal direction of the polymer thin film P. For example, when the emitter 110 is arranged so as to be inclined at an angle of 30 degrees from the normal direction of the polymer thin film P, the detector 120 may be arranged so as to be inclined at an angle of −30 degrees from the normal direction of the polymer thin film P to form bilateral symmetry with the emitter 110.

As described, when the emitter 110 and the detector 120 are provided to operate in the reflection mode, the detector 120 may detect terahertz waves generated from the emitter 110 and reflected from a surface of the target substrate W, which is an interface between the target substrate W and the polymer thin film P.

For example, when the emitter 110 and the detector 120 are arranged in the reflection mode with an angle of 30 degrees on both left and right sides based on the normal direction of the polymer thin film P, terahertz waves generated from the emitter 110 and incident on the polymer thin film P at an angle of 60 degrees may be primarily refracted according to a difference in refractive indexes between air and the polymer thin film P, moved inside the polymer thin film P, reflected from the surface of the target substrate W, secondarily refracted at an angle of −60 degrees from an interface between the air and the polymer thin film P, and received by the detector 120.

In this case, angles and directions of the emitter 110 and the detector 120 may be precisely adjusted. For example, the precisely adjusted emitter 110 and the precisely adjusted detector 120 may have six degrees of freedom. The six degrees of freedom of the emitter 110 and the detector 120 may represent three axes in x-, y-, and z-directions, and rotational directions about the respective axes.

According to one embodiment of the present invention, the detector 120 may further detect terahertz waves reflected from an inside of the target substrate W. To this end, a reflection plate R may be arranged on a lower side of the target substrate W.

As described above, information on the terahertz waves generated from the emitter 110, reflected from the surface of the target substrate W or the inside of the target substrate W, and detected by the detector 120 may be used to calculate a thickness and a refractive index of the polymer thin film P, which is for monitoring a curing state of the polymer thin film P coated on the target substrate W in real time.

Meanwhile, as shown in FIG. 3, according to one modified example of the present invention, the emitter 110 and the detector 120 may be provided so as to be operable in a transmission mode based on an optical path of the terahertz wave with respect to the polymer thin film P.

To this end, the emitter 110 may be arranged on the polymer thin film P to face the polymer thin film P in the normal direction, and the detector 120 may be arranged on a lower side of the polymer thin film P in the normal direction of the polymer thin film P, and arranged in a direction facing the emitter 110 while being arranged on the same line as the emitter 110 with the polymer thin film P interposed therebetween.

Accordingly, the terahertz waves generated from the emitter 110 may be transmitted through the polymer thin film P and detected by the detector 120.

In addition, as shown in FIG. 4, according to another modified example of the present invention, a first emitter 110 and a first detector 120 may be provided so as to be operable in a normal mode based on an optical path of the terahertz wave with respect to the polymer thin film P.

To this end, the emitter 110 may be arranged on the polymer thin film P to face the polymer thin film P in the normal direction such that an angle of incidence of the terahertz wave on the polymer thin film P may be 0 degrees. In this case, a beam splitter may be provided on the optical path of the terahertz wave generated from the emitter 110 and directed toward the polymer thin film P.

The detector 120 may be provided on one side of the beam splitter to detect the terahertz waves split by the beam splitter.

Although a conventional reflection mode has a limitation that a spot shape of the terahertz wave is not a perfectly circular shape because the terahertz waves are incident while being inclined, when the first emitter 110 and the first detector 120 are provided so as to be operable in the normal mode, the terahertz waves may be incident perpendicularly to the polymer thin film P so that precision of a measurement region may be increased.

In addition, as shown in FIG. 5, according to still another modified example of the present invention, a first emitter 110 and a first detector 120 may be provided so as to be operable in a reflection mode based on an optical path of the terahertz wave with respect to the polymer thin film P.

In addition, according to still another modified example of the present invention, a second emitter 110′ and a second detector 120′ may be provided so as to be operable in a transmission mode based on an optical path of the terahertz wave with respect to the polymer thin film P.

In other words, according to still another modified example of the present invention, the polymer monitoring device 100 may operate in a multi-mode in which the reflection mode of the first emitter 110 and the first detector 120 and the transmission mode of the second emitter 110′ and the second detector 120′ are combined.

To this end, the first emitter 110 and the first detector 120 may be arranged so as to be inclined symmetrically with each other on both sides based on the normal direction of the polymer thin film P.

For example, when the emitter 110 and the detector 120 are arranged in the reflection mode with an angle of 30 degrees on both left and right sides based on the normal direction of the polymer thin film P, terahertz waves generated from the emitter 110 and incident on the polymer thin film P at an angle of 60 degrees may be primarily refracted according to a difference in refractive indexes between air and the polymer thin film P, moved inside the polymer thin film P, reflected from the surface of the target substrate W, secondarily refracted at an angle of −60 degrees from an interface between the air and the polymer thin film P, and received by the detector 120.

In addition, the second emitter 110′ and the second detector 120′ may be arranged so as to face each other in the normal direction of the polymer thin film P on upper and lower sides of the polymer thin film P with the polymer thin film P interposed therebetween.

Accordingly, the terahertz waves generated from the second emitter 110′ may be transmitted through the polymer thin film P and detected by the second detector 120′.

Meanwhile, according to one embodiment of the present invention, one or more emitters 110 and one or more detectors 120 may be provided. In this case, when two or more emitters 110 and two or more detectors 120 are provided, the emitters 110 and the detectors 120 may be provided such that the number of the emitters 110 and the number of the detectors 120 may correspond to each other so as to form pairs.

In addition, according to one embodiment of the present invention, the emitter 110 and the detector 120 may target an entire polymer thin film P. As described above, when the emitter 110 and the detector 120 target the entire polymer thin film P, the emitter 110 and the detector 120 may scan an entire area of the polymer thin film P.

To this end, the emitter 110 and the detector 120 may be provided so as to be movable in forward, rearward, left, and right directions.

As described above, when the entire area of the polymer thin film P is scanned by the emitter 110 and the detector 120, the curing state of the polymer thin film P may be monitored more accurately.

In addition, when the entire area of the polymer thin film P is scanned by the emitter 110 and the detector 120, for example, it is possible to determine which step of the photolithography process is in progress.

For example, when the photoresist (PR) is coated on the target substrate W through spin coating, a thickness of a central portion of the coated photoresist (PR) may become temporarily thinner than a thickness of an edge of the coated photoresist (PR) due to a centrifugal force.

According to one embodiment of the present invention, the polymer monitoring device 100 may monitor a difference in the thicknesses between the central portion and the edge of the photoresist (PR) in real time through the emitter 110 and the detector 120, which scan the entire area of the polymer thin film P, and may perform cause analysis that the difference in the thicknesses has occurred due to the spin coating, not a process issue.

In addition, according to one embodiment of the present invention, the polymer monitoring device 100 may acquire refractive index information by scanning the photoresist (PR) during an exposure process after the spin coating through the emitter 110 and the detector 120, and may monitor curing degree distribution across an entire area of the wafer W based on the refractive index information.

As described above, the reason for monitoring the curing degree distribution across the entire area of the wafer W is that patterning defects and the like due to lack of uniformity of a curing degree of the wafer W may occur during an actual process. Meanwhile, according to one embodiment of the present invention, the polymer monitoring device 100 may also perform monitoring by predicting a curing state of an entire area of the photoresist (PR) through a thickness of a specific region, for example, the central portion and the edge of the photoresist (PR) by using the emitter 110 and the detector 120.

Referring again to FIG. 2, the monitoring unit 130 may acquire thickness and refractive index information of the polymer thin film P in real time through the terahertz waves detected by the detector 120 during curing of the polymer thin film P.

The monitoring unit 130 may monitor the curing state of the polymer thin film P coated on the target substrate W in real time based on the thickness and refractive index information of the polymer thin film P acquired in real time as described above.

Accordingly, an immediate reaction may be taken upon occurrence of a problem in a polymer curing process, such as an abnormality in the polymer thin film P and an abnormality in a curing device.

In other words, according to one embodiment of the present invention, the curing state of the polymer thin film P coated on the target substrate W may be monitored in real time so that an active measure for enhancing a yield may be taken during the process.

For example, according to one embodiment of the present invention, a curing state of the photoresist (PR) may be monitored in real time during the photolithography process so that an immediate reaction may be taken upon occurrence of a problem.

In particular, according to one embodiment of the present invention, the curing state of the photoresist (PR) may be monitored in real time during the photolithography process so that excellent curing quality of the photoresist (PR) for stable etching in large wafer areas and fine line widths may be achieved.

As shown in FIG. 6, the terahertz waves generated from the emitter 110 and emitted toward the polymer thin film P coated on the target substrate W may be divided into terahertz waves (1st Peak) reflected from the surface of the target substrate W and terahertz waves (2nd Peak, 3rd Peak, and 4th Peak) reflected from the inside of the target substrate W according to a reflection location.

Accordingly, the monitoring unit 130 may acquire the thickness and refractive index information of the polymer thin film P in real time through the terahertz waves (1^{st} Peak) reflected from the surface of the target substrate W and the terahertz waves (2^{nd} Peak, 3^{rd} Peak, and 4^{th} Peak) reflected from the inside of the target substrate W during the curing of the polymer thin film P.

In this case, among the terahertz waves detected by the detector 120, the terahertz waves (1^{st} Peak) reflected from the surface of the target substrate W may have the largest amplitude.

Accordingly, according to one embodiment of the present invention, the monitoring unit 130 may acquire the thickness and refractive index information of the polymer thin film P in real time during the curing of the polymer thin film P based on the terahertz waves (1^{st} Peak) reflected from the surface of the target substrate W.

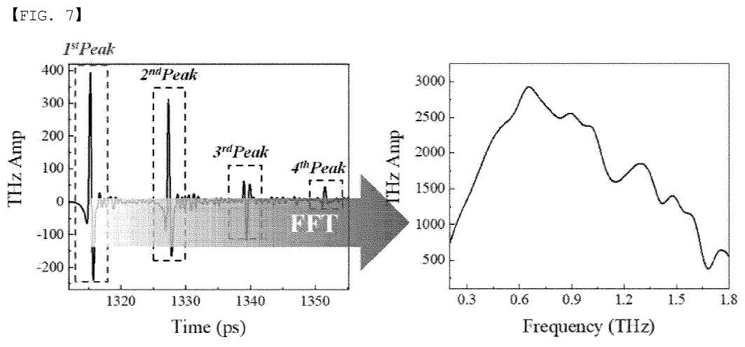

As shown in FIG. 7, the monitoring unit 130 may perform fast Fourier transformation (FFT) on the terahertz waves (1^{st} Peak) reflected from the surface of the target substrate W, and monitor the curing state of the polymer thin film P.

According to one embodiment of the present invention, the monitoring unit 130 may calculate a refractive index and a thickness of the polymer thin film P in consideration of a ratio of a frequency domain value of the terahertz waves in the target substrate W and a frequency domain value of the terahertz waves in a reference substrate.

In this case, the reference substrate may be defined as a substrate that is not coated with the polymer thin film P.

According to one example, the frequency domain value of the terahertz waves in the reference substrate may refer to a frequency domain value of the terahertz waves, which may serve as a reference. For example, the frequency domain value of the terahertz waves in the reference substrate may include at least one of a frequency domain value of the terahertz waves reflected from the reflection plate, a frequency domain value of the terahertz waves measured in a vacuum, a frequency domain value of the terahertz waves subjected to total reflection, and a frequency domain value of the terahertz waves transmitted in the transmission mode.

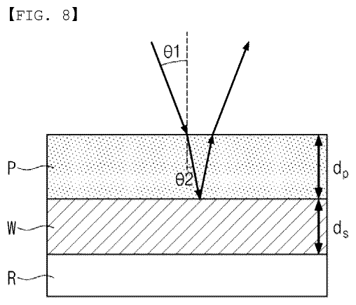

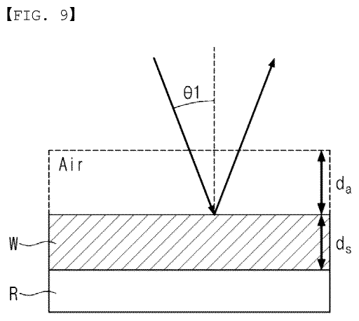

As shown in FIGS. 8 and 9, for example, the monitoring unit 130 may numerically calculate the refractive index and the thickness of the polymer thin film P in consideration of a ratio of a frequency domain value of the terahertz waves reflected from the surface of the target substrate W having a top surface coated with the polymer thin film P and a frequency domain value of the terahertz waves reflected from a surface of the reference substrate W having a top surface that is not coated with the polymer thin film P.

According to one embodiment of the present invention, the refractive index (ñₚ) of the polymer thin film P may be calculated through Formula 1 below.

$$\begin{matrix}\frac{FFT [ {E}_{t} ( t ) ]}{FFT [ {E}_{r} ( t ) ]} = \frac{{T}_{ap} \cdot {D}_{p} \cdot {R}_{ps} \cdot {D}_{p} \cdot {T}_{pa}}{{D}_{a} \cdot {R}_{as} \cdot {D}_{a}} = ρ \cdot {e}^{- j φ} \\ = \frac{4 {\tilde{n}}_{a} {\tilde{n}}_{p} cos ( θ1 ) cos ( θ 2 )}{{( {\tilde{n}}_{p} cos ( θ 2 ) + {\tilde{n}}_{a} cos ( θ 1 ) )}^{2}} . {e}^{- j ( 2 \frac{{\tilde{n}}_{p} ω {d}_{p}}{c} - 2 \frac{ω {d}_{a}}{c} )}\end{matrix} \qquad [ Formula 1 ]$$

In addition, according to one embodiment of the present invention, the thickness (dₚ) of the polymer thin film P may be calculated through Formula 2 below.

$${d}_{p} = cos ( θ 2 ) \frac{φ c}{2 ω ( {\tilde{n}}_{p} - 1 )} \qquad [ Formula 2 ]$$

In this case, Eₜ (t) is a terahertz wave reflected from a surface of a target substrate coated with a polymer thin film, Eᵣ (t) is a terahertz wave reflected from a surface of a reference substrate, ω is a frequency of a terahertz wave, φ is a phase difference between a terahertz wave reflected from a surface of a target substrate coated with a polymer thin film and a terahertz wave reflected from a surface of a reference substrate, c is a speed of light, θ1 is an angle of incidence of a terahertz wave, θ2 is an angle of refraction of a terahertz wave, Tₐₚ and Tₚₐ are transmittance coefficients between air (a) and a polymer thin film, Dₐ is an absorption coefficient of air, Dₚ is an absorption coefficient of a polymer thin film, Rₚₛ is a reflection coefficient between a target substrate and a polymer thin film, Rₐₛ is a reflection coefficient between a reference substrate and air, dₐ is a thickness of an air layer that is set to correspond to a polymer thin film, and ñₐ is a refractive index of an air layer.

Formulas 1 and 2, which reflect the optical path of the terahertz wave, have been expanded by setting terahertz waves reflected from a surface of a silicon wafer coated with the photoresist (PR) as sample waves (FIG. 8) and setting terahertz waves reflected from a surface of a silicon wafer that is not coated with the photoresist (PR) as reference waves (FIG. 9).

According to one embodiment of the present invention, the monitoring unit 130 may substitute sample wave information and reference wave information into Formulas 1 and 2, and numerically calculate the refractive index (ñₚ) of the polymer thin film P and the thickness (dₚ) of the polymer thin film P through repeated numerical analysis.

Accordingly, the monitoring unit 130 may monitor the curing state of the polymer thin film P in real time during the curing of the polymer thin film P.

Accordingly, an immediate reaction may be taken upon occurrence of a problem in a polymer curing process, such as an abnormality in the polymer thin film P and an abnormality in a curing device.

In this case, referring again to FIG. 4, when the first emitter 110 and the first detector 120 are provided so as to be operable in the normal mode, an angle of incidence of the terahertz waves that are incident on the polymer thin film P may be 0 degrees so that each of cos (01) and cos (02) values in Formulas 1 and 2 may become 1, and thus a calculation process may be simplified so as to increase measurement accuracy.

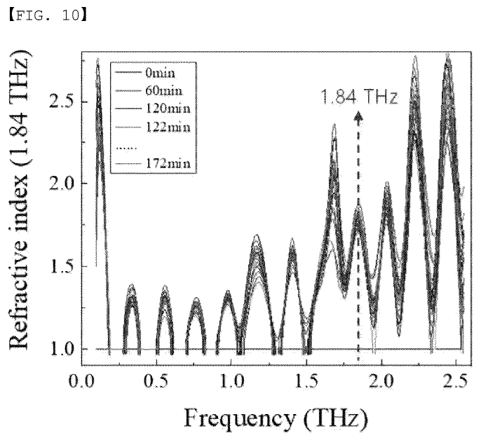

FIGS. 10 and 11 show results of monitoring a curing state of a photoresist coated on a silicon wafer during curing of the photoresist through the polymer monitoring device according to one embodiment of the present invention.

In other words, FIGS. 10 and 11 show results of numerically calculating the refractive index and the thickness of the photoresist through the terahertz waves reflected from the surface of the silicon wafer.

Referring to FIGS. 10 and 11, it was found that the refractive index of the photoresist (PR) increases due to the coating of the photoresist (PR), and converges to a specific value as the curing progresses.

In this case, it was found that the thickness of the photoresist (PR) exhibits a similar tendency to the refractive index as the curing progresses.

As described above, it was found that the refractive index and the thickness of the photoresist (PR) may be numerically calculated through the terahertz waves reflected from the surface of the silicon wafer so that the curing state of the photoresist (PR) may be monitored in real time during the curing of the photoresist (PR).

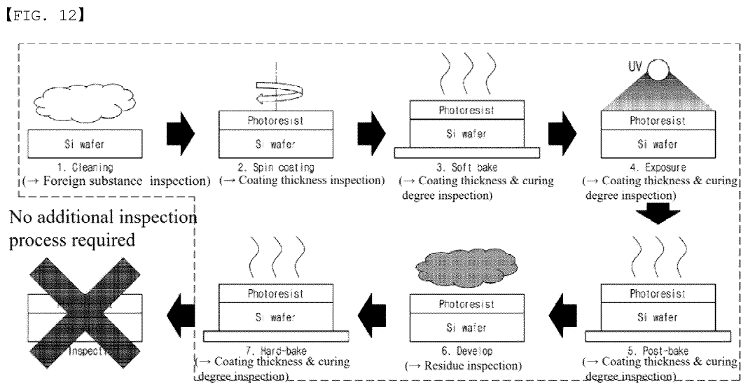

FIG. 12 is a schematic view for describing a photolithography process monitored in real time by the polymer monitoring device according to one embodiment of the present invention.

As shown in FIG. 12, according to one embodiment of the present invention, the polymer monitoring device may monitor the curing state of the photoresist cured on the silicon wafer in real time in all steps of the photolithography process, for example, a cleaning step, a spin coating step, a soft bake step, an exposure step, a post-bake step, a development step, and a hard bake step, for example, through the terahertz waves reflected from the surface of the silicon wafer, so that an additional inspection process after the curing may not be required.

Accordingly, according to the polymer monitoring device of one embodiment of the present invention, a process completion time may be shortened, and damage to the photoresist caused by a physical device for inspecting the curing state may be prevented in advance.

Referring again to FIG. 2, according to one embodiment of the present invention, the polymer monitoring device 100 may further include a database DB.

The database DB may store a reference range for a refractive index and a thickness for each stage of the curing of the polymer thin film P.

For example, the database DB may store a reference range for a refractive index and a thickness of the photoresist (PR) in each of the cleaning step, the spin coating step, the soft bake step, the exposure step, the post-bake step, the development step, and the hard bake step of the photolithography process.

Accordingly, the monitoring unit 130 may monitor whether the thickness and refractive index information of the photoresist (PR) acquired in real time is included in the reference range.

In other words, the monitoring unit 130 may determine whether the refractive index and the thickness of the photoresist (PR) calculated through Formulas 1 and 2 are included in the reference range for the refractive index and the thickness of the photoresist (PR) in the corresponding step of the photolithography process.

When it is determined that the refractive index and the thickness of the photoresist (PR) calculated through Formulas 1 and 2 are included in the reference range for the refractive index and the thickness of the photoresist (PR) in the corresponding step of the photolithography process, the monitoring unit 130 may determine that the curing of the photoresist (PR) is being properly performed without any abnormality.

On the contrary, when it is determined that the refractive index and the thickness of the photoresist (PR) calculated through Formulas 1 and 2 are not included in the reference range for the refractive index and the thickness of the photoresist (PR) in the corresponding step of the photolithography process, the monitoring unit 130 may determine that a problem such as an abnormality in the photoresist (PR) or an abnormality in a curing device has occurred in the corresponding step of the photolithography process.

When it is determined that a problem has occurred in the corresponding step of the photolithography process, the monitoring unit 130 may alert a process manager or an operator to a result of monitoring in which an abnormality is detected.

Accordingly, the monitoring unit 140 may allow an immediate reaction to be taken upon occurrence of a problem in a polymer curing process.

In other words, the monitoring unit 140 may allow an active measure for enhancing a yield to be taken during the polymer curing process.

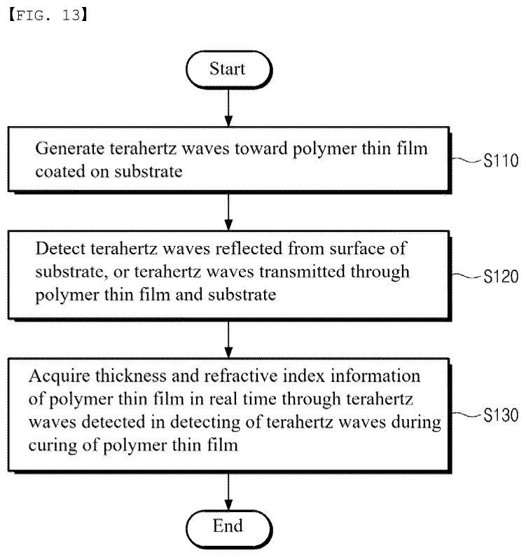

Hereinafter, a polymer monitoring method using terahertz waves according to one embodiment of the present invention will be described with reference to FIG. 13. In this case, reference numerals for respective elements will be given with reference to FIG. 1.

FIG. 13 is a flowchart showing, in a process order, a polymer monitoring method using terahertz waves according to one embodiment of the present invention.

Referring to FIG. 13, according to one embodiment of the present invention, the polymer monitoring method using the terahertz waves may include a step S110, a step S120, and a step S130.

### Step S110

The step S110 may refer to a step of generating terahertz waves toward a polymer thin film P coated on a target substrate W.

In this case, in the step S110, the terahertz waves may be generated toward the polymer thin film P through a reflection mode.

To this end, in the step S110, for example, the terahertz waves may be generated such that the terahertz waves may be incident on the polymer thin film P at an angle that is greater than 0° and less than 90°.

In addition, in the step S110, the terahertz waves may be generated toward the polymer thin film P through a transmission mode.

To this end, in the step S110, the terahertz waves may be generated such that the terahertz waves may be incident on the polymer thin film P in a normal direction of the polymer thin film P.

In addition, in the step S110, the terahertz waves may be generated toward the polymer thin film P through a multi-mode in which the reflection mode and the transmission mode are combined. To this end, in the step S110, the terahertz waves may be generated such that the terahertz waves may be incident on the polymer thin film P at an angle that is greater than 0° and less than 90°, and simultaneously, the terahertz waves may be generated such that the terahertz waves may be incident on the polymer thin film P in the normal direction of the polymer thin film P.

### Step S120

The step S120 may refer to a step of detecting terahertz waves reflected from a surface of the target substrate W, or terahertz waves transmitted through the polymer thin film P and the target substrate W.

When the terahertz waves are generated toward the polymer thin film P in the reflection mode in the step S110, the terahertz waves reflected from the surface of the target substrate W may be detected in the step S120.

In this case, in the step S120, terahertz waves reflected from an inside of the target substrate W may also be detected.

In addition, when the terahertz waves are generated toward the polymer thin film P through the transmission mode in the step S110, the terahertz waves transmitted through the polymer thin film P and the target substrate W may be detected in the step S120.

When the polymer thin film P is provided alone, rather than coated on the target substrate W, the transmission mode may be more preferable.

In addition, when the terahertz waves are generated toward the polymer thin film P through the multi-mode in which the reflection mode and the transmission mode are combined in the step S110, in the step S120, the terahertz waves transmitted through the polymer thin film P and the target substrate W may be detected, and simultaneously, the terahertz waves reflected from the surface of the target substrate W or the inside of the target substrate W may be detected.

Meanwhile, in the step S110, for comparison with the target substrate W coated with the polymer thin film P, terahertz waves may be further generated toward a reference substrate W that is not coated with the polymer thin film P, for example, through the reflection mode.

Accordingly, in the step S120, terahertz waves in the reference substrate, for example, terahertz waves reflected from a surface of the reference substrate may be further detected.

Furthermore, according to one embodiment of the present invention, in the step S110 and the step S120, an entire area of the polymer thin film P may be scanned. Accordingly, in the step S130, the entire area of the polymer thin film P may be monitored.

As another example, in the step S130, a curing state of the entire area of the polymer thin film P may be predicted through terahertz waves reflected from each region of the polymer thin film P.

### Step S130

The step S130 may refer to a step of acquiring thickness and refractive index information of the polymer thin film P in real time through the terahertz waves detected in the step S120 during curing of the polymer thin film P.

In the step S130, the thickness and refractive index information of the polymer thin film P may be acquired in real time through the terahertz waves (1^{st} Peak) reflected from the surface of the target substrate W and the terahertz waves (2^{nd} Peak, 3^{rd} Peak, and 4^{th} Peak) reflected from the inside of the target substrate W during the curing of the polymer thin film P.

In this case, among the terahertz waves detected through the step S120, the terahertz waves (1^{st} Peak) reflected from the surface of the target substrate W may have the largest amplitude.

Accordingly, in the step S130, the thickness and refractive index information of the polymer thin film P may be acquired in real time during the curing of the polymer thin film P based on the terahertz waves (1^{st} Peak) reflected from the surface of the target substrate W.

According to one embodiment of the present invention, in the step S130, fast Fourier transformation (FFT) may be performed on the terahertz waves (1^{st} Peak) reflected from the surface of the target substrate W, and the curing state of the polymer thin film P may be monitored.

In more detail, in the step S130, a refractive index and a thickness of the polymer thin film P may be calculated in consideration of a ratio of a frequency domain value of the terahertz waves in the target substrate W and a frequency domain value of the terahertz waves in the reference substrate.

In this case, the reference substrate may be defined as a substrate W that is not coated with the polymer thin film P.

For example, in the step S130, the refractive index and the thickness of the polymer thin film P may be numerically calculated in consideration of a ratio of a frequency domain value of the terahertz waves reflected from the surface of the target substrate W having a top surface coated with the polymer thin film P and a frequency domain value of the terahertz waves reflected from a surface of the reference substrate W having a top surface that is not coated with the polymer thin film P.

According to one embodiment of the present invention, the refractive index (ñₚ) of the polymer thin film P may be calculated through Formula 1 below.

$$\begin{matrix}\frac{FFT [ {E}_{t} ( t ) ]}{FFT [ {E}_{r} ( t ) ]} = \frac{{T}_{ap} \cdot {D}_{p} \cdot {R}_{ps} \cdot {D}_{p} \cdot {T}_{pa}}{{D}_{a} \cdot {R}_{as} \cdot {D}_{a}} = ρ \cdot {e}^{- j φ} \\ = \frac{4 {\tilde{n}}_{a} {\tilde{n}}_{p} cos ( θ1 ) cos ( θ 2 )}{{( {\tilde{n}}_{p} cos ( θ 2 ) + {\tilde{n}}_{a} cos ( θ 1 ) )}^{2}} . {e}^{- j ( 2 \frac{{\tilde{n}}_{p} ω {d}_{p}}{c} - 2 \frac{ω {d}_{a}}{c} )}\end{matrix} \qquad [ Formula 1 ]$$

In addition, according to one embodiment of the present invention, the thickness (dₚ) of the polymer thin film P may be calculated through Formula 2 below.

$${d}_{p} = cos ( θ 2 ) \frac{φ c}{2 ω ( {\tilde{n}}_{p} - 1 )} \qquad [ Formula 2 ]$$

In this case, Eₜ (t) is a terahertz wave reflected from a surface of a target substrate coated with a polymer thin film, Eᵣ (t) is a terahertz wave reflected from a surface of a reference substrate, ω is a frequency of a terahertz wave, φ is a phase difference between a terahertz wave reflected from a surface of a target substrate coated with a polymer thin film and a terahertz wave reflected from a surface of a reference substrate, c is a speed of light, θ1 is an angle of incidence of a terahertz wave, θ2 is an angle of refraction of a terahertz wave, Tₐₚ and Tₚₐ are transmittance coefficients between air (a) and a polymer thin film, Dₐ is an absorption coefficient of air, Dₚ is an absorption coefficient of a polymer thin film, Rₚₛ is a reflection coefficient between a target substrate and a polymer thin film, Rₐₛ is a reflection coefficient between a reference substrate and air, dₐ is a thickness of an air layer that is set to correspond to a polymer thin film, and ñₐ is a refractive index of an air layer.

Formulas 1 and 2, which reflect the optical path of the terahertz wave, have been expanded by setting terahertz waves reflected from a surface of a silicon wafer coated with the photoresist (PR) as sample waves (FIG. 8) and setting terahertz waves reflected from a surface of a silicon wafer that is not coated with the photoresist (PR) as reference waves (FIG. 9).

According to one embodiment of the present invention, in the step sample wave information and reference wave information may be substituted into Formulas 1 and 2, and the refractive index (ñₚ) of the polymer thin film P and the thickness (dₚ) of the polymer thin film P may be numerically calculated through repeated numerical analysis. Accordingly, the curing state of the polymer thin film P may be monitored in real time during the curing of the polymer thin film P.

Accordingly, an immediate reaction may be taken upon occurrence of a problem in a polymer curing process, such as an abnormality in the polymer thin film P and an abnormality in a curing device.

In other words, according to one embodiment of the present invention, the curing state of the polymer thin film P coated on the target substrate W may be monitored in real time so that an active measure for enhancing a yield may be taken during the process.

For example, according to one embodiment of the present invention, a curing state of the photoresist (PR) may be monitored in real time during the photolithography process so that an immediate reaction may be taken upon occurrence of a problem.

In particular, according to one embodiment of the present invention, the curing state of the photoresist (PR) may be monitored in real time during the photolithography process so that excellent curing quality of the photoresist (PR) for stable etching in large wafer areas and fine line widths may be achieved.

In addition, according to one embodiment of the present invention, an additional inspection process after completion of the curing of the photoresist (PR) may not be required, so that a process completion time may be shortened, and damage to the photoresist (PR) caused by a physical device for inspecting the curing state may be prevented in advance.

Although the exemplary embodiments of the present invention have been described in detail above, the scope of the present invention is not limited to a specific embodiment, and shall be interpreted by the appended claims. In addition, it is to be understood by a person having ordinary skill in the art that various changes and modifications may be made without departing from the scope of the present invention.

1. A polymer monitoring device using terahertz waves, the polymer monitoring device comprising:
an emitter for generating terahertz waves toward a polymer thin film coated on a target substrate;
a detector for detecting terahertz waves generated from the emitter and reflected from a surface of the target substrate, or terahertz waves transmitted through the polymer thin film and the target substrate; and
a monitoring unit for acquiring thickness and refractive index information of the polymer thin film in real time through the terahertz waves detected by the detector during curing of the polymer thin film.

2. The polymer monitoring device of claim 1, wherein the monitoring unit calculates a refractive index and a thickness of the polymer thin film in consideration of a ratio of a frequency domain value of the terahertz waves in the target substrate and a frequency domain value of the terahertz waves in a reference substrate, and
the reference substrate is defined as a substrate that is not coated with the polymer thin film.

3. The polymer monitoring device of claim 2, wherein the refractive index (ñₚ) of the polymer thin film is calculated through Formula 1 below, and
the thickness (dₚ) of the polymer thin film is calculated through Formula 2 below,
$$\begin{matrix}\frac{FFT [ {E}_{t} ( t ) ]}{FFT [ {E}_{r} ( t ) ]} = \frac{{T}_{ap} \cdot {D}_{p} \cdot {R}_{ps} \cdot {D}_{p} \cdot {T}_{pa}}{{D}_{a} \cdot {R}_{as} \cdot {D}_{a}} = ρ \cdot {e}^{- j φ} \\ = \frac{4 {\tilde{n}}_{a} {\tilde{n}}_{p} cos ( θ1 ) cos ( θ 2 )}{{( {\tilde{n}}_{p} cos ( θ 2 ) + {\tilde{n}}_{a} cos ( θ 1 ) )}^{2}} . {e}^{- j ( 2 \frac{{\tilde{n}}_{p} ω {d}_{p}}{c} - 2 \frac{ω {d}_{a}}{c} )}\end{matrix} \qquad [ Formula 1 ]$$
$${d}_{p} = cos ( θ 2 ) \frac{φ c}{2 ω ( {\tilde{n}}_{p} - 1 )} \qquad [ Formula 2 ]$$
where Eₜ (t) is a terahertz wave reflected from a surface of a target substrate coated with a polymer thin film, Eᵣ (t) is a terahertz wave reflected from a surface of a reference substrate, ω is a frequency of a terahertz wave, φ is a phase difference between a terahertz wave reflected from a surface of a target substrate coated with a polymer thin film and a terahertz wave reflected from a surface of a reference substrate, c is a speed of light, θ1 is an angle of incidence of a terahertz wave, θ2 is an angle of refraction of a terahertz wave, Tₐₚ and Tₚₐ are transmittance coefficients between air (a) and a polymer thin film, Dₐ is an absorption coefficient of air, Dₚ is an absorption coefficient of a polymer thin film, Rₚₛ is a reflection coefficient between a target substrate and a polymer thin film, Rₐₛ is a reflection coefficient between a reference substrate and air, dₐ is a thickness of an air layer that is set to correspond to a polymer thin film, and ñₐ is a refractive index of an air layer.

4. The polymer monitoring device of claim 1, wherein the detector further detects terahertz waves reflected from an inside of the target substrate, and
the monitoring unit is able to acquire the thickness and refractive index information of the polymer thin film in real time even through the terahertz waves reflected from the inside of the target substrate.

5. The polymer monitoring device of claim 1, wherein the emitter and the detector scan an entire area of the polymer thin film.

6. The polymer monitoring device of claim 1, further comprising:
a database,
wherein the database stores a reference range for a refractive index and a thickness for each stage of the curing of the polymer thin film, and
the monitoring unit monitors whether the thickness and refractive index information of the polymer thin film acquired in real time is included in the reference range.

7. The polymer monitoring device of claim 6, wherein the monitoring unit provides a result of the monitoring as cause analysis data for an abnormality occurrence when the thickness and refractive index information of the polymer thin film is not included in the reference range.

8. The polymer monitoring device of claim 1, wherein at least one emitter and at least one detector are provided such that a number of emitters corresponds to a number of detectors.

9. The polymer monitoring device of claim 1, wherein the emitter and the detector are provided so as to be operable in one measurement mode among a transmission mode, a normal mode, a reflection mode, and a multi-mode in which the transmission mode and the reflection mode are combined based on an optical path of the terahertz wave with respect to the polymer thin film.

10. The polymer monitoring device of claim 1, wherein the terahertz waves are provided as pulsed waves or continuous waves.

11. The polymer monitoring device of claim 1, wherein a frequency of the terahertz wave is 0.1 THz to 10 THz.

12. A polymer monitoring method using terahertz waves, the polymer monitoring method comprising:
generating terahertz waves toward a polymer thin film coated on a target substrate;
detecting terahertz waves reflected from a surface of the target substrate, or terahertz waves transmitted through the polymer thin film and the target substrate; and
acquiring thickness and refractive index information of the polymer thin film in real time through the terahertz waves detected in the detecting of the terahertz waves during curing of the polymer thin film.

13. The polymer monitoring method of claim 12, wherein in the generating of the terahertz waves, terahertz waves is further generated toward a reference substrate that is not coated with the polymer thin film,
in the detecting of the terahertz waves, reference terahertz waves is further detected from the reference substrate, and
in the acquiring in real time, a refractive index and a thickness of the polymer thin film are calculated in consideration of a ratio of a frequency domain value of the terahertz waves in the target substrate and a frequency domain value of the terahertz waves in the reference substrate.

14. The polymer monitoring method of claim 12, wherein in the generating of the terahertz waves and the detecting of the terahertz waves, an entire area of the polymer thin film is scanned.
